(19) United States
(12) Patent Application Publication
(10) Pub. No.: US 2022/0284034 A1
(43) Pub. Date: Sep. 8, 2022

(54) REPLICATING DATA CHANGES OF A SOURCE DATABASE IN A TARGET DATABASE USING DATA CHANGE RECORDS AND RUNTIME STATISTICS OF THE SOURCE DATABASE

(71) Applicant: International Business Machines Corporation, Armonk, NY (US)

(72) Inventors: Knut Stolze, Hummelshain (DE); Felix Beier, Haigerloch (DE); Reinhold Geiselhart, Rottenburg-Ergenzingen (DE); Luis Eduardo Oliveira Lizardo, Böblingen (DE)

(21) Appl. No.: 17/189,671

(22) Filed: Mar. 2, 2021

(51) Int. Cl. G06F 16/27; G06F 11/34; G06F 16/23

(52) U.S. Cl. CPC G06F 16/27; G06F 11/3452; G06F 11/3428; G06F 16/2379

(57) ABSTRACT

The present disclosure relates to a computer implemented method for replicating data changes of a source table in a target table. Methods, computer program products, and/or systems are provided that perform the following operations: loading first runtime statistics about processing the data changes of the source table at a first point of time; repeatedly generating data change records while performing the data changes of the source table, the data change records comprising information about the data changes of the source table; storing the data change records on a storage device; loading second runtime statistics about processing the data changes of the source table at a second point of time; and selecting a type of data replication from a first type of data replication and a second type of data replication depending on the first runtime statistics and the second runtime statistics.

### BACKGROUND

The present invention relates to the field of database technology, and more specifically, to a method for replicating data changes of a table of a source database system in a table of a target database system.

A replication of data changes done in the table of the source database system in the table of the target database system may be performed to create a backup of the table of the source database. Another application of such a replication of data changes may be to synchronize the table of the target database system with the table of the source database system, the table of the target database system comprising a different ordering scheme than the table of the source database system. A further use case for the replication of data changes may involve making data available on different machines, with the different machines located in different geographic locations. For example, data may be replicated from a server in the United States of America to a server in Europe to enable a faster access to the data in Europe. The faster access may be provided by reduced network transmission times due to shorter cables.

Generally, the replication of data changes should be performed as fast as possible to maintain data of the table of the target database system as synchronously as possible to data of the table of the source database system. The data changes may be replicated according to different types of replication strategies. A first type may comprise individually replicating single rows of the table of the source database system. A further type of replication strategy may comprise replicating several rows, even a bulk of rows or all the rows of the table of the source database at once.

### SUMMARY

Various embodiments provide a computer system, a computer program product, and a method for replicating data changes as described by the subject matter of the independent claims. Advantageous embodiments are described in the dependent claims. Embodiments of the present invention can be freely combined with each other if they are not mutually exclusive.

According to an aspect of the present invention, there are methods, computer program products, and/or systems provided that perform the following operations (not necessarily in the following order): loading first runtime statistics about processing the data changes of the source table at a first point of time; repeatedly generating data change records while performing the data changes of the source table, the data change records comprising information about the data changes of the source table; storing the data change records on a storage device; loading second runtime statistics about processing the data changes of the source table at a second point of time; and selecting a type of data replication from a first type of data replication and a second type of data replication depending on the first runtime statistics and the second runtime statistics; wherein the first type of data replication includes loading the data change records from the storage device and replicating respective data changes of the source table in the target table according to the respective loaded data change records; and wherein the second type of data replication includes loading information about data values of several rows of the source table and updating several rows of the target table on the basis of the information about the data values of the several rows of the source table.

### BRIEF DESCRIPTION OF THE SEVERAL VIEWS OF THE DRAWINGS

In the following embodiments of the invention are explained in greater detail, by way of example only, with reference to the drawings in which:

FIG. 1 illustrates an example computer system comprising a computer system/server in accordance with embodiments of the present invention;

FIG. 2 illustrates a second example computer system/server of the computer system shown in FIG. 1 in accordance with embodiments of the present invention;

FIG. 3 depicts a network connected to the computer system of FIG. 1 in accordance with embodiments of the present invention;

FIG. 4 depicts a source database system, a target database system, a first memory device, and a second memory device for performing a data replication of the source database system in the target database system in accordance with embodiments of the present invention;

FIG. 5 depicts a table of the source database system in accordance with embodiments of the present invention;

FIG. 6 depicts a table of the target database system in accordance with embodiments of the present invention;

FIG. 7 depicts a runtime statistics file being generated while performing data changes of the table of the source database system in accordance with embodiments of the present invention;

FIG. 8 depicts data change records being generated while performing data changes of the table of the source database system in accordance with embodiments of the present invention;

FIG. 9 depicts log files being generated while performing data changes of the table of the source database system in accordance with embodiments of the present invention;

FIG. 10 depicts a first record of data changes and a second record of data changes in accordance with embodiments of the present invention;

FIG. 11 depicts the source database system, the target database system, the first memory device, and the second memory device as shown in FIG. 4, with the first memory device and second memory device storing the log files of FIG. 9 and the data change records of FIG. 8 in accordance with embodiments of the present invention; and

FIG. 12 depicts a flowchart of a first embodiment of a computer implemented method for replicating data changes of a table of the source database system shown a in a table of the target database system in accordance with embodiments of the present invention.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Data change records as a whole may include all necessary information to replicate all the data changes of a source table. A source database system may generate each data change record while, or in response to, performing a respective data change of the data changes of the source table. Hence, in one example, each data change record may correspond to one of the data changes of the source table. The respective data change record may comprise all necessary information to replicate the corresponding data change of the source table.

A single data change of the source table may comprise a change of a value of a single data field of the source table or a change of values of several data fields of a single row of the source table. The single data field may be specified by a number (e.g., identifier, etc.) of a row and a number (e.g., identifier, etc.) of a column of the source table. The value of the single data field may be a number or a character. The necessary information to replicate a single data change may include, for example, a new data value of a single data field of the source table after the data change has been performed and the number of the row and the number of the column of the source table specifying the single data field. In a case where a single data change may include change of the values of several data fields of a single row of the source table, the necessary information to replicate the single data change may include, for example, a respective new data value of each data field of the row of the source table being modified when performing the single data change, the number of the row comprising these modified data fields and the number of a respective column indicating each modified data field.

With each new data change of the source table being performed, a new data change record may be generated including the necessary information to replicate that data change in a target table. The data change records may be stored on a storage device individually and/or gathered in the form of log files, for example. The storage device may be, for example, a cache of a processor, a solid-state-drive (SSD), a flash memory, a hard disk drive, a tape, and/or the like. In some embodiments, the storage device may be comprised by a source database system, a target database system, or a further component. In some embodiments, the further component may be a computing device associated with and/or included as part of a network including the source database system and the target database system. A new data change record may be written in an actual log file on the source database system. The new record may be written in the actual log file at a position following the last written data change record in the actual log file. The last written record may indicate the last performed data change of the source table before performing the new data change of the source table. As such, an order of data changes of the source table may be represented by an order of the data change records in the actual log file.

A new log file may be generated if a size of the actual log file reaches a given threshold. Therefore, various log files may be generated repeatedly. If a new log file is generated and becomes the updated actual log file in response to its generation, the former actual log file may be stored on a storage device. As a source table may be maintained for a long period of time, for example years or decades, a total number of data changes of a source table may be greater than one thousand, one million, one billion, etc. A total number of data changes may be higher than a total number of data fields or rows of a source table as the data fields may be changed several times in a lifetime of a source table.

The data changes may be in the form of changing values of data fields of the source table as described above. The data changes may also include deleting of one or several rows and/or columns of the source table or inserting of one or several rows and/or columns in the source table.

In some embodiments, first runtime statistics may include a first total number of values of data fields of a source table being changed in a lifetime of the source table, referred to in the following as first total number value changes. In some embodiments, for the first runtime statistics, a lifetime may end at a first point of time. According to one example, the first runtime statistics may comprise a first total number of data fields and/or rows of a source table being changed in a lifetime of the source table, referred to in the following as first total number of changed data fields and first total number of changed rows respectively.

Additionally, first runtime statistics may include a first total number of rows and/or columns being inserted in a source table in a lifetime of the source table, referred to in the following as first total number of inserted rows and as first total number of inserted columns respectively. Furthermore, first runtime statistics may include a first total number of rows and/or columns being deleted from a source table in a lifetime of the source table, referred to in the following as first total number of deleted rows and as first total number of deleted columns respectively. In some embodiments, as an example, the first runtime statistics may comprise a first total number of the data changes of a source table being performed in a lifetime of the source table.

In some embodiments, second runtime statistics may include a second total number of values of data fields of a source table being changed in a lifetime of the source table, referred to in the following as second total number value changes. In some embodiments, for the second runtime statistics, a lifetime may end at a second point of time. According to one example, second runtime statistics may include a second total number of data fields and/or rows of a source table being changed in a lifetime of the source table, referred to in the following as second total number of changed data fields and second total number of changed rows respectively.

Additionally, second runtime statistics may include a second total number of rows and/or columns being inserted in a source table in a lifetime of the source table, referred to in the following as second total number of inserted rows and as second total number of inserted columns respectively. Furthermore, second runtime statistics may include a second total number of rows and/or columns being deleted from a source table in a lifetime of the source table, referred to in the following as second total number of deleted rows and as second total number of deleted columns respectively. In some embodiments, as an example, second runtime statistics may comprise a second total number of the data changes of a source table being performed in a lifetime of the source table.

In some embodiments, the first and second runtime statistics may be saved in a first statistics file and a second statistics file respectively. The first statistics file and second statistics file may be stored in a source database system. Hence, the loading of the first runtime statistics may be performed by loading the first statistics file from the source database system. In some embodiments, the first and second runtime statistics may be stored in a storage device of a source database system, a target database system, and/or the further component. In some embodiments, the further component may be a data replication engine.

A first type of data replication may include loading the data change records and/or a subset of the data change records from a storage device into a target database system. The target database system may store a target table and may include a processor for replicating the data changes in the target table based on the data change records. The target database system may replicate the data changes in the target table one by one. The order of the data changes of a source table may be similar to an order of the data changes in a target table. The first type of data replication may be considered as an incremental data replication.

Given a first situation in which the data values of the source table are each equal to the data values of the target table, the first replication strategy may be selected in order to transfer the least amount of data from the source database system to the target database system. However, frequency of performing the data changes in the source table may vary over time. In a situation where a frequency of performing data changes is comparatively high, for example compared to an average value of this frequency, the number of stored log filed on a storage device may reach an upper limit such that no more log files may be stored on the storage device. A subsequent large number of stored log files may result in older log files being moved (e.g., archived) to other storage devices, for example slower and/or cheaper storage devices. As such, the retrieval of older stored log files for replication of data changes to the target table may take longer due to accessing the slower storage device. An increasing replication latency may further result in more stored log files accumulating while older stored log files are being retrieved for replication and possibly cause additional older stored log files to be moved to the other (e.g., slower/cheaper) storage device exacerbating the situation.

To prevent this issue, a second type of replication strategy may be selected to speed up the replicating of the data changes before a significant accumulation of stored log files may occur. The second type of data replication may include loading information about the data values of rows of the source table from the source database system. The data values of rows of the source table may be replicated from the source database system to the target table of the target database system. The rows of a source table being replicated to a target table may include all the rows of the source table and/or may be a subset of all the rows of the source table. The second type of data replication may be considered as a bulk load replication (e.g., full table reload, partial table reload, etc.). A full bulk load replication would include all the rows of the source table (e.g., full table reload, etc.) and a partial bulk load replication would include a subset of rows of the source table (e.g., partial table reload, etc.). According to aspects of the present disclosure, a type of data replication can be determined based on first runtime statistics and second runtime statistics. Selecting the type of data replication depending on the first runtime statistics and the second runtime statistics may provide the advantage that the selecting may be performed using data available with a system comprising the source database system other than the number of stored log files on the storage device.

Additionally, information given by the first and second runtime statistics, for example by the first statistics file and second statistics file, may be read faster than information given by the data change records depending on the information. In some embodiments, for example, To assess a total number of value changes of data fields of the source table being performed between the first point of time and the second point of time and which may have to be replicated in the target table, a difference between the second total number value changes and first total number value changes may be calculated. Though it may not, in some cases, provide an exact number of replicated data changes in the target table between the first point of time and second point of time, this difference may give an estimate about a number of data changes to be replicated in the target table. Alternatively, to obtain an estimate about the data changes to be replicated using the data change records, all the data change records may have to be read, for example. Reading the first statistics file and the second statistics file may be a lot faster than reading all the data change records.

In some embodiments, the loading of the information about the data values of several rows of the source table may comprise loading all data values of the source table from the source database system. Accordingly, the updating of the several rows of the target table on the basis of the information about the data values of the several rows of the source table may involve copying all data values of the source table to the target table. Each data field of the source table may be assigned to one data field of the target table with both data fields comprising the same value after the copying. The loading of all data values of the source table may involve loading the source table from the source database to the target database. This may have the advantage that the target table and the source table may be in a synchronous state or almost synchronous state after the loading of all data values of the source table and performing the second type of data replication. The synchronous state of the source table and the target table may provide that the value of each of the data fields of the target table may be equal to the respective value of the respective data field of the source table. In some cases, the target table and the source table may be in an almost synchronous state after the loading and the copying because while performing the copying new data, changes may be performed in the source table.

In some embodiments, the data change records being stored on the storage device may be ignored if the second type of data replication is selected as there may be no need to keep information about data changes of the source table being performed before loading the complete information of the source table from the source database system. In some embodiments, for example, these data change records may be deleted to create space on the storage device if the second type of data replication is selected.

In some embodiments, the loading of the first runtime statistics may comprise a loading of information about the first total number of the data changes of the source table at the first point of time and the loading of the second runtime statistics may comprise a loading of information about the second total number of the data changes of the source table at the second point of time. Such embodiments may provide for selecting the type of data replication depending on the information about the first total number of the data changes and the information about the second total number of the data changes.

The first total number of the data changes may be a sum of the first total number of changed data fields, the first total number of changed rows, the first total number of inserted rows, the first total number of inserted columns, the first total number of deleted rows, and/or the first total number of deleted columns.

Similarly, the second total number of the data changes may be a sum of the second total number of changed data fields, the second total number of changed rows, the second total number of inserted rows, the second total number of inserted columns, the second total number of deleted rows, and/or the second total number of deleted columns.

In some embodiments, for example, the information about the first and second total number of data changes may, respectively, be the first and second total number of data changes themselves. In some embodiments, as another example, the information about the first and second total number of data changes may be in the form of a first counter and a second counter, respectively, each counter ignoring the same number of initial data changes of the source table. In some embodiments, for example, the initial data changes may involve inserting all columns and rows of the source table and initializing all data fields of the source table.

In some embodiments, selecting the type of data replication on the basis of the first total number of data changes and the second total number of data changes may have the advantage that by using these two values, a fast and simple decision may be made regarding selection of either the first or the second type of data replication. This may allow for a fast computation. Further, such a decision process may be easily understood by a user monitoring a replication of the data changes.

Furthermore, some such embodiments may allow for building a replication database in a simple manner In some embodiments, a replication database may store the first and second total number of data changes, a decision of which one of the first and the second data replication type is selected, and whether an overflow of the storage device occurs after this decision was taken. The replication database may serve for optimizing the selection of the type of data replication. Generally, an optimization problem may be solved easier and faster the less variables involved. As the first and the second total number of data changes may aggregate several other variables, for example the first and second total number of changed data fields and/or changed rows, the optimization problem may be alleviated by using the first and the second total number of data changes.

In some embodiments, the method may include replicating a first number of data changes of the source table in the target table according to the data change records on the storage device and according to the first type of data replication between the first point of time and the second point of time. These data changes may be also referred to in the following as replicated data changes. The phrase “first number of data changes” may refer to a set of the data changes comprising an amount of data changes being equal to a first number. in some embodiments, the method may include determining a number of pending data changes of the target table on the basis of the first number, the first total number of data changes and the second total number of data changes. The method may include selecting the type of data replication from the first type of data replication and the second type of data replication based on the number of pending data changes of the target table.

In some embodiments, the method may include performing the selecting of the second type of data replication if the number of pending data changes of the target table is greater than a first threshold. Such embodiments may allow for automating the replication type selection. In some embodiments, the first threshold may be set by the user.

In some embodiment, using the number of pending data changes for performing the selection of the type of data replication may allow for shifting a change from the first type of data replication to the second type of data replication to a later moment of time compared to performing the selection on the basis of the first and second total number of data changes. This is because the first threshold may be reached later if the number of the replicated data changes is taken into account. The later a switch from the first to the second type of data replication may be performed, the less amount of data has to be transferred from the source database system to the target database system. As such, such embodiments may reduce the data transfer between these two database systems.

In some embodiments, if the second type of data replication is selected and the loading of the information about the data values of the several rows of the source table comprises loading all data values of the source table, the method may include resetting a counter for counting the first number of replicated data changes and repeating operations including:
the loading of the information about the first total number of the data changes of the source table at the first point of time, with the first total number being an updated first total number and with the first point of time being an updated first point of time;
repeatedly generating the data change records while performing the data changes of the source table, with the data change records being updated data change records;
the storing of the data change records on the storage device;
the replicating of the first number of the data changes of the source table in the target table according to the data change records on the storage device and according to the first type of data replication between the first point of time and the second point of time, the first number of the data changes being an updated first number of the data changes, the data change records on the storage device being updated data change records on the storage device, the second point of time being an updated second point of time;
the loading of the information about the second total number of the data changes of the source table at a second point of time, with the second total number being an updated second total number;
the determining of the number of the pending data changes of the target table on the basis of the first number of the data changes, the first total number of the data changes and the second total number of the data changes, the number of the pending data changed being an updated number of the pending data changes; and
the selecting of the type of data replication from the first type of data replication and the second type of data replication depending on the number of the pending data changes of the target table.

The resetting of the counter, the first total number being an updated first total number, the first point of time being an updated first point of time, the first number of the data changes being an updated first number of the data changes, the data change records on the storage device being updated data change records on the storage device, the second point of time being an updated second point of time, the second total number being an updated second total number and the number of the pending data changed being an updated number of the pending data changes may allow performing an automated repeating of the above described tasks, such as the loading, the repeatedly generating, the storing, the replicating, and so forth. Moreover, the resetting and updating may allow for using the same variables and arrays in a program. To summarize, such embodiments may provide for an automated repetition of selecting the type of data replication in response to selecting the second type of data replication.

In some embodiments, if the first type of data replication is selected, the method may include resetting the counter for counting the first number of data changes and replacing the information about the first total number of the data changes with the information about the second total number of the data changes and repeating operations including:
repeatedly generating the data change records while performing the data changes of the source table, with the data change records being updated data change records;
the storing of the data change records on the storage device;
the replicating of the first number of the data changes of the source table in the target table according to the data change records on the storage device and according to the first type of data replication between the first point of time and the second point of time, the first number of the data changes being an updated first number of the data changes, the data change records on the storage device being updated data change records on the storage device, the second point of time being an updated second point of time;
the loading of the information about the second total number of the data changes of the source table at a second point of time, with the second total number being an updated second total number;
the determining of the number of the pending data changes of the target table on the basis of the first number of the data changes, the first total number of the data changes and the second total number of the data changes, the number of the pending data changed being an updated number of the pending data changes; and
the selecting of the type of data replication from the first type of data replication and the second type of data replication depending on the number of the pending data changes of the target table.

The resetting and the updating of variables and data arrays such as the counter for counting the first number of data changes, the first number of the data changes, and so forth may allow for performing an automated repetition of the above described tasks, such as the repeatedly generating, the storing, the replicating, and so forth. Moreover, the resetting and updating may allow for using the same variables and arrays in a program. Additionally, replacing the information about the first total number of the data changes with the information about the second total number of the data changes may allow for skipping the task of the loading of the information about the first total number of the data changes while performing the repetition.

In some embodiments, the method may include determining the first threshold such that a length of a first period of time for performing the number of the pending data changes of the target table according to the first type of data replication is approximately equal to a length of a second period of time for copying all data values of the source table to the target table. Determining the first threshold in such a manner may provide that a switch from the first to the second type of data replication is only done if computation time for performing the pending data changes is saved. The length of the first period of time may be estimated depended on a previously performed time measurement of an execution of the first type of data replication. Similarly, the length of the second period of time may be estimated depending on a previously performed time measurement of an execution of the second type of data replication.

Furthermore, as the number of the pending data changes may be determined on the basis of the first and second total number of the data changes and the first threshold may be determined using the number of the pending data changes, the first threshold may be calculated on the actual statistical data of the source database system available. Thus, a decision regarding switching from the first to the second type of data replication and thereby a decision on saving computation time may be performed more accurately using the first and second runtime statistics compared to using only information given by the data change records.

In some embodiments, the method may include determining the first threshold based on an access time of the storage device. The access time may be defined by a time which it may take to perform a write or read command after the storage device has received the write or read command. This may allow for calculating the length of the first period of time as accurately as possible.

The storage device may be a hard disk drive and/or a tape and may comprise a moving element for accessing data being stored on the storage device, for example a rotating disk or tape. The access time may include, for example, a time interval used for positioning a disk read-and-write head of the storage device according to the read command, also known as seek time. In another example, the storage device may be a solid-state-drive (SSD) or a flash memory. As such, the storage device may not comprise moving elements for reading out data stored on the storage device.

In some embodiments, the method may include determining the first threshold based on an access time of a target database system. The access time of the target database system may be defined by a time which it may take to perform the loading of all the data values of the source table from the source database system either on the target database system or on an intermediate storage device after the source database system has received a load command for initiating the loading of all the data values of the source table. The intermediate storage device may be an above-mentioned storage device. This may allow for calculating the length of the second period of time as accurately as possible.

In some embodiments, the method may include selecting the type of data replication from the first type of data replication and the second type of data replication based on the difference between the second total number and the first total number. As mentioned above, this may allow a quick and easy to follow decision on which type of data replication may be selected.

In some embodiments, the method may include selecting the type of data replication from the first type of data replication and the second type of data replication based on a difference between the second total number and the first total number and a number of pending queries on the source database system. The number of pending queries may give an outlook for a future usage of the source table and an amount of required replications of data changes in the future. As such, including the number of pending queries may include a key figure influencing the amount of required replications of data changes in the future. In doing so, reaching and/or exceeding a maximum limit of log files that may be stored on a storage device, as discussed above, may be prevented.

In some embodiments, the method may include selecting the type of data replication from the first type of data replication and the second type of data replication based on a rate of data changes per time of the source table. The rate of data changes per time may be dependent on the difference between the first total number and the second total number and a length of a time interval between the first point of time and the second point of time. Using the rate of data changes per time of the source table for the decision making on which type of data replication may be selected may improve the decision making as the rate of data changes per time of the source table may influence the amount of required replications of data changes in the future. Thus, this may provide for preventing the reaching and/or exceeding of a maximum limit of log files that may be stored on a storage device, as discussed above.

In some embodiments, the loading of the information about the data values of several rows of the source table may include loading the data values of the several rows of the source table from the source database system. In some embodiments, the several rows may be a subset of all the rows of the source table. In such cases, the second type of data replication may be considered as a partial bulk load, wherein a part of the data values of several rows or blocks of rows of the source table may be copied from a source database system to a target database system. Performing a partial bulk load may reduce computational costs compared to a full bulk load, in which all the data values are copied from the source table to the target table. However, performing the partial bulk load may be sufficient to prevent reaching and/or exceeding a maximum limit of log files that may be stored on a storage device, in some cases.

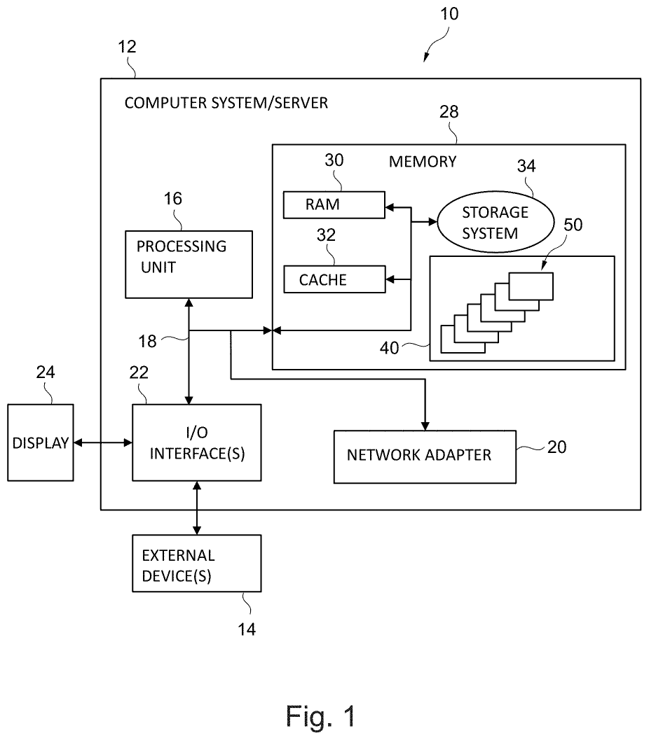

Embodiments of the present invention may be implemented using a computing device that may also be referred to as a computer system, a client, and/or a server. Referring now to FIG. 1, a schematic of an example of a computer system 10 is shown. The computer system 10 provides one example of a suitable computer system and is not intended to suggest any limitation as to the scope of use and/or functionality of embodiments of the invention as described herein. Regardless, computer system 10 is capable of implementing and/or performing any of the functionality set forth herein.

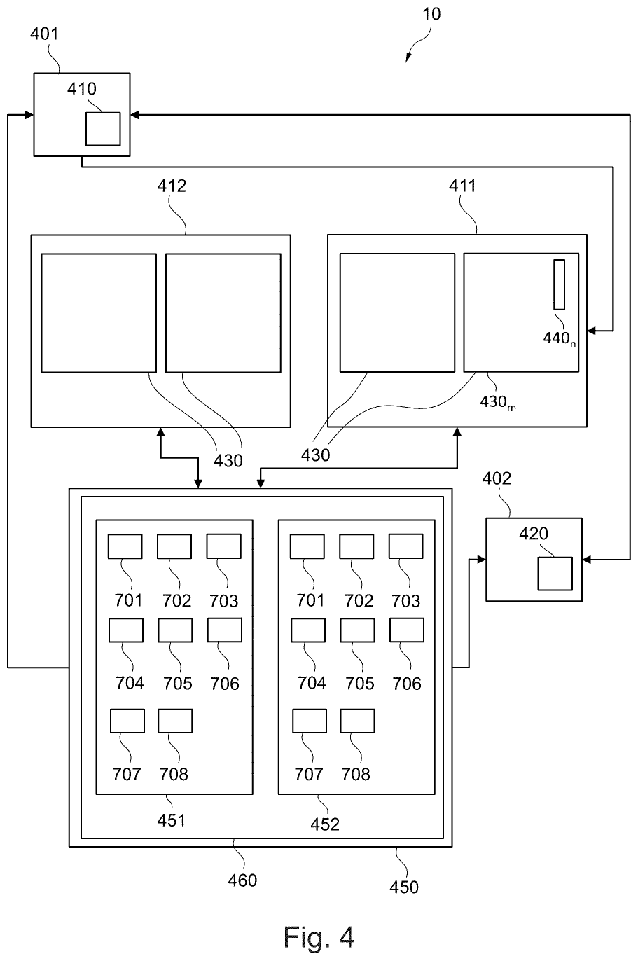

The computer system 10 may comprise a first computer system/server 12, which may be operational with numerous other general-purpose or special-purpose computing system environments or configurations. Examples of well-known computing systems, environments, and/or configurations that may be suitable for use with first computer system/server 12 include, but are not limited to, a first storage device, such as a first storage device 411 of the computer system 10 shown in FIG. 4, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed computing environments that include any of the above systems or devices, and the like.

The first computer system/server 12 may be described in the general context of computer system executable instructions, such as program modules, being executed by a computer system. Generally, program modules may include routines, programs, objects, components, logic, data structures, and so on that perform particular tasks or implement particular abstract data types. The first computer system/server 12 may be practiced in distributed computing environments where tasks are performed by remote processing devices that are linked through a communications network. In a distributed computing environment, program modules may be located in both local and remote computer system storage media including memory storage devices.

As shown in FIG. 1, the first computer system/server 12 in computer system 10 is shown in the form of a general-purpose computing device. The components of the first computer system/server 12 may include, but are not limited to, one or more processors or processing units 16, a system memory 28, and a bus 18 that couples various system components including system memory 28 to processor 16. Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The first computer system/server 12 typically includes a variety of computer system readable media. Such media may be any available media that is accessible by the first computer system/server 12, and it includes both volatile and non-volatile media, removable and non-removable media.

System memory 28 can include computer system readable media in the form of volatile memory, such as random-access memory (RAM) 30 and/or cache memory 32. The first computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 50, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 50 generally may be configured to carry out the functions and/or methodologies of embodiments of the invention as described herein.

The term “program” or “program module” as used herein refers to a set of instructions which may contain commands to provoke actions performed by the processor 16 when the processor 16 may read the commands. The set of instructions may be in the form of a computer-readable program, routine, subroutine or part of a library, which may be executed by the processor 16 and/or may be called by a further program being executed by the processor 16. Preferably the program modules 50 may be executable programs which are compiled according to a type of hardware platform of the first computer system/server 12.

The first computer system/server 12 may also communicate with one or more external devices 14 such as a keyboard, a pointing device, a display 24, etc.; one or more devices that enable a user to interact with the first computer system/server 12; and/or any devices (e.g., network card, modem, etc.) that enable the first computer system/server 12 to communicate with one or more other computing devices. Such communication can occur via Input/Output (I/O) interfaces 22. Additionally, the first computer system/server 12 may communicate with one or more networks such as a local area network (LAN), a general wide area network (WAN), and/or a public network (e.g., the Internet) via network adapter 20. As depicted, network adapter 20 may communicate with the other components of the first computer system/server 12 via bus 18. It should be understood that although not shown, other hardware and/or software components could be used in conjunction with the first computer system/server 12. Examples, include, but are not limited to: microcode, device drivers, redundant processing units, external disk drive arrays, RAID systems, tape drives, and data archival storage systems, etc.

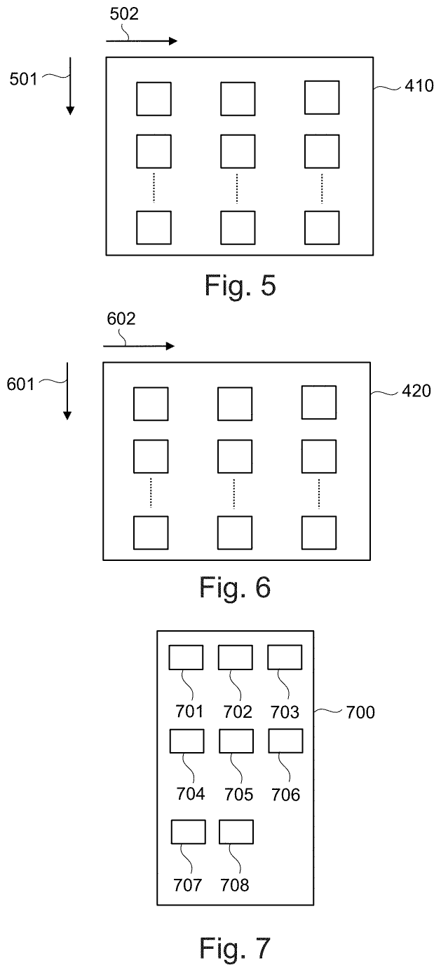

In some embodiments, as an example, the first computer system/server 12 may be designed in the form of a source database system, such as a source database system 401 shown in FIG. 4. The source database system 401 may comprise a source table 410 as shown in FIGS. 4 and 5. The source table 410 may comprise data fields, shown as boxes in FIG. 5. The data fields may each include a value, for example a number or a character. For each data field of the source table 410, a specific row number of the source table 410 and a specific column number of the source table 410 may be assigned. The specific row number of the source table 410 may increase in the direction of the first arrow 501 shown in FIG. 5. The specific column number of the source table 410 may increase in the direction of the second arrow 502 shown in FIG. 5. The row number and the column number of each data field may be used to perform a data change of the respective data field (e.g., a change of value, etc.). In addition, a selected row number of the source table 410 and several different selected column numbers of the source table 410 may be used to perform several data changes of different data fields of a single row being specified by the selected row number. The source table 410 may be stored in the storage system 34 of the first computer system/server 12, as an example.

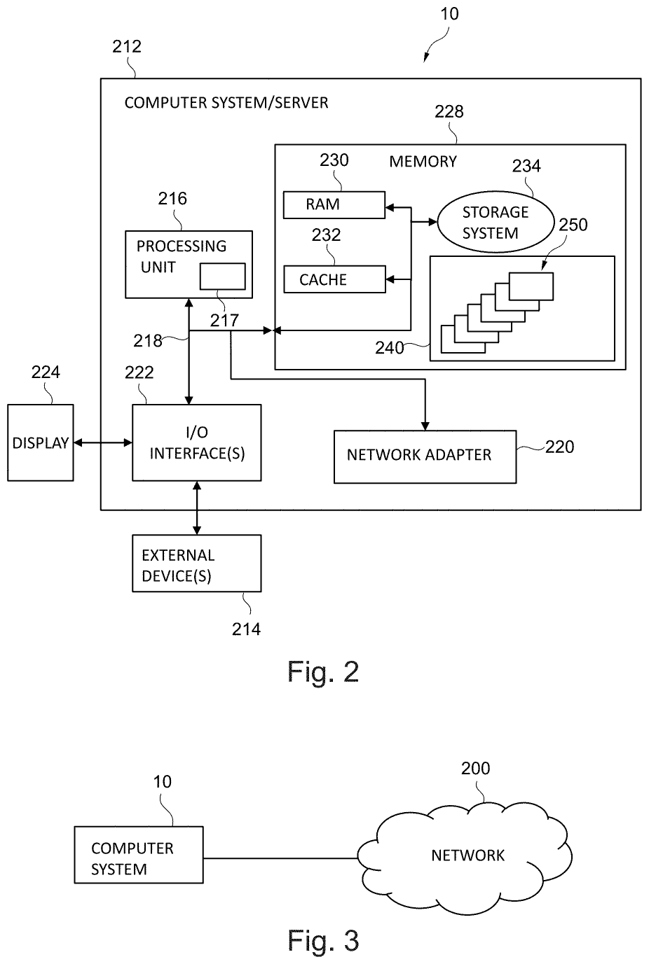

The computer system 10 may comprise a second computer system/server 212, as shown in FIG. 2, which may be operational with numerous other general-purpose or special purpose computing system environments or configurations. Examples of well-known computing systems, environments, and/or configurations that may be suitable for use with second computer system/server 212 include, but are not limited to, the first storage device 411 of FIG. 4, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed computing environments that include any of the above systems or devices, and the like.

The second computer system/server 212 may be described in the general context of computer system executable instructions, such as program modules, being executed by a computer system. Generally, program modules may include routines, programs, objects, components, logic, data structures, and so on that perform particular tasks or implement particular abstract data types. The second computer system/server 212 may be practiced in distributed computing environments where tasks are performed by remote processing devices that are linked through a communications network. In a distributed computing environment, program modules may be located in both local and remote computer system storage media including memory storage devices.

As shown in FIG. 2, the second computer system/server 212 in computer system 10 is shown in the form of a general-purpose computing device. The components of the second computer system/server 212 may include, but are not limited to, one or more processors or processing units 216, a system memory 228, and a bus 218 that couples various system components including system memory 228 to processor 216. Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The second computer system/server 212 typically includes a variety of computer system readable media. Such media may be any available media that is accessible by the second computer system/server 212, and it includes both volatile and non-volatile media, removable and non-removable media.

System memory 228 can include computer system readable media in the form of volatile memory, such as random-access memory (RAM) 230 and/or cache memory 232. The second computer system/server 212 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the invention.

Program/utility 240, having a set (at least one) of program modules 250, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 250 generally may be configured to carry out the functions and/or methodologies of embodiments of the invention as described herein.

The term “program” or “program module” as used herein refers to a set of instructions which may contain commands to provoke actions performed by the processor 216 when the processor 216 may read the commands. The set of instructions may be in the form of a computer-readable program, routine, subroutine or part of a library, which may be executed by the processor 216 and/or may be called by a further program being executed by the processor 216. Preferably the program modules 250 may be executable programs which are compiled according to a type of hardware platform of the second computer system/server 212.

The second computer system/server 212 may also communicate with one or more external devices 214 such as a keyboard, a pointing device, a display 224, etc.; one or more devices that enable a user to interact with the second computer system/server 212; and/or any devices (e.g., network card, modem, etc.) that enable the second computer system/server 212 to communicate with one or more other computing devices. Such communication can occur via Input/Output (I/O) interfaces 222. Additionally, the second computer system/server 212 may communicate with one or more networks such as a local area network (LAN), a general wide area network (WAN), and/or a public network (e.g., the Internet) via network adapter 220. As depicted, network adapter 220 may communicate with the other components of the second computer system/server 212 via bus 218. It should be understood that although not shown, other hardware and/or software components could be used in conjunction with the second computer system/server 212. Examples, include, but are not limited to: microcode, device drivers, redundant processing units, external disk drive arrays, RAID systems, tape drives, and data archival storage systems, etc.

In some embodiments, as an example, the second computer system/server 212 may be designed in the form of a target database system, such as target database system 402 shown in FIG. 4. The target database system 402 may comprise a target table 420 as shown in FIGS. 4 and 6. The target table 420 may comprise data fields. The data fields of the target table 420 may each include a value, for example a number or a character. For each data field of the target table 420, a specific row number of the target table 420 and a specific column number of the target table 420 may be assigned. The specific row number of the target table 420 may increase in the direction of the first arrow 601 as shown in FIG. 6. The specific column number of the target table 420 may increase in the direction of the second arrow 602 as shown in FIG. 6. The row number and the column number of each data field may be used to perform a data change of the respective data field (e.g., a change of value, etc.). In addition, a selected row number of the target table 420 and several different selected column numbers of the target table 420 may be used to perform several data changes of different data fields of a single row being specified by the selected row number. The target table 420 may be stored in the storage system 234 of the second computer system/server 212, as an example.

In some embodiments, a computer system, such as the computer system 10 shown in FIG. 1, may be used for performing operations disclosed herein such as at least a first, second, third, fourth, fifth, sixth, and seventh operation discussed below.

In some embodiments, the computer system 10 may be configured for replicating data changes of the source table 410 of the source database system 401 in the target table 420 of the target database system 402.

In some embodiments, a first operation may comprise loading first runtime statistics about processing the data changes of the source table 410 at a first point of time. The source table 410 may be stored in the storage system 34 and/or the like. A part of the source table 410, for example several rows or blocks of rows of the source table 410, may be stored in the RAM 30 and/or cache memory 32 when the processor 16 may process the data changes. The processor 16 may generate a runtime statistics file, such as runtime statistics file 700 shown in FIG. 7, before, during, and/or after processing one or more of the data changes.

In some embodiments, the runtime statistics file 700 may comprise a total number of the values of the data fields of the source table 410 being changed in a lifetime of the source table 410 being represented by a value of a first variable 701. Furthermore, the runtime statistics file 700 may comprise a total number of data fields and rows of the source table being changed in the lifetime of the source table being represented by a value of a second variable 702 and a third variable 703 respectively. Furthermore, the runtime statistics file 700 may comprise a total number of rows and columns being inserted in the source table 410 in the lifetime of the source table 410 being represented by a value of a fourth variable 704 and a fifth variable 705 respectively. Furthermore, the runtime statistics file 700 may comprise a total number of rows and columns being deleted from the source table 410 in the lifetime of the source table being represented by a value of a sixth variable 706 and a seventh variable 707 respectively. In one example, the runtime statistics file 700 may comprise a total number of data changes being performed in a lifetime of the source table 410. As an example, the total number of data changes may be equal to a number of times a single row and/or column of the source table 410 has been changed in a lifetime of the source table 410. In this case, an inserting or a deleting of a single row or column of the source table 410 may also be counted as a data change. As another example, a change of a value of a single data field of a single row may be counted as one data change for determining the total number of data changes. The total number of data changes may be represented by a value of an eighth variable 708 in the runtime statistics file 700.

In some embodiments, the processor 16 may update one or more of the variables 701, 702, 703, 704, 705, 706, 707, and/or 708 when processing the data changes. The loading of the first runtime statistics may comprise loading each value of one or more of the variables 701, 702, 703, 704, 705, 706, 707, and/or 708 at the first point of time. As an example, the processor 16 may generate a first runtime statistics file 451 which may be a copy of the runtime statistics file 700 at the first point of time. A further processing unit 450 may send a first load command to initiate a download of the first runtime statistics file 451 or each value of one or more of the variables 701, 702, 703, 704, 705, 706, 707, and/or 708 of the runtime statistics file 700 from the source database system 401 into a memory 460 of the further processing unit 450. Hence, the further processing unit 450 may execute the first operation. Using the runtime statistics file 700 may present one variant to store and update the variables 701, 702, 703, 704, 705, 706, 707, and/or 708. In another variant, the variables 701, 702, 703, 704, 705, 706, 707, and/or 708 may be stored without writing them in the runtime statistics file 700. For example, the variables 701, 702, 703, 704, 705, 706, 707, and/or 708 may be stored in the cache memory 32 separately.

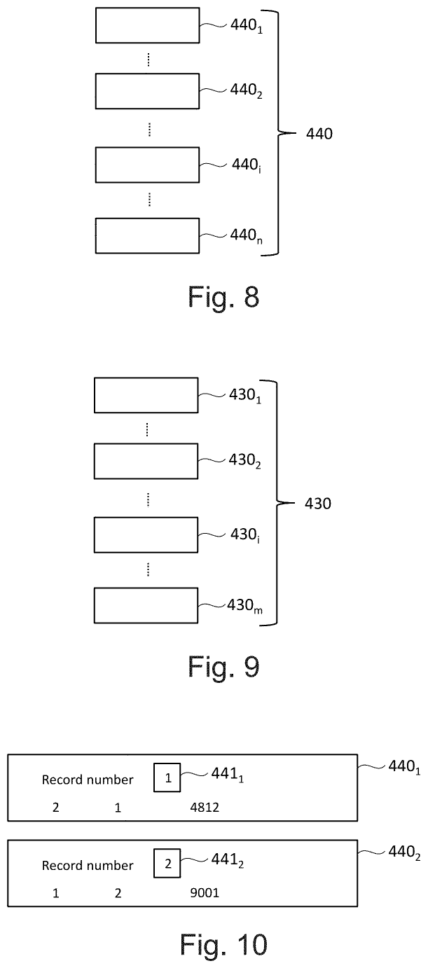

In some embodiments, a second operation may comprise repeatedly generating data change records, such as data change records 440 shown in FIG. 8, while performing the data changes of the source table 410. The processor 16 may write the data change records 440 in log files, such as log files 430 shown in FIG. 9. The processor 16 may perform each data change of the source table 410 by provoking a writing on the storage system 34 on which the source table 410 may be stored. Each log file 430ᵢ may comprise at least one data change record of the source table 410. The second operation may be performed by means of the source database system 401, for example by means of the processor 16.

In some embodiments, the processor 16 may generate the data change records such that each one of the data change records 440 may comprise all the necessary information, as described above, to replicate the respective data change of the source table 410 in the target table 420. The processor 16 may generate a new data change record 440ₙ with every new data change of the source table 410, for example, by repeatedly generating data change records while performing the data changes. The processor 16 may execute additional data changes of additional source tables not shown in the figures. Furthermore, the processor 16 may generate additional data change records comprising the necessary information to replicate the additional data changes of the additional source tables. The additional records may be written in additional log files not shown in the figures and/or in the log files 430. Thus, it may occur that the log files 430 comprise one or more of the additional data change records not shown in the figures. Additionally, it may occur that one or more of the additional log files are stored in between the log files 430.

In some embodiments, the new record 440ₙ may be generated by writing the necessary information to replicate the new data change in an actual log file 430ₘ. For each further new data change, a further new data change record may be generated in the same way as the new record 440ₙ. Accordingly, for several further new data changes several further new data change records may be generated. FIG. 8 shows a set of generated data change records 440 which the source database system 401 may have generated. Each data change record 440ᵢ may comprise the necessary information, as described above, to replicate a data change of the source table 410 corresponding to the respective data change record 440ᵢ. For example, the source database system 401 may have generated a first data change record 440₁, after that a second data change record 440₂, and so forth. The last record being generated may be the new record 440ₙ.

In some embodiments, a third operation may comprise storing the data change records 440 on the first storage device 411. For example, the processor 16 may store the log files 430 on the first storage device 411. Alternatively, or in addition, the storing of the data change records 440 may be realized by a further processing unit 450 storing the log files 430 on the first storage device 411. The source database system 401 may be connected to the first storage device 411 and/or the further processing unit 450 via the (I/O) interfaces 22 and/or via the network adapter 20. The first storage device 411 may comprise a first access time. In some embodiments, the first access time may be in the range of 35 to 100 microseconds, for example. FIG. 4 shows an example where each one of the log files 430ᵢ, including the actual log file 430ₘ, may be generated directly on the first storage device 411. This may be realized by sending write commands from the source database system 401 to the further processing unit 450 of the computer system 10.

As another example, in some embodiments, the log files 430ᵢ may be written internally in the source database system 401 and after that may be sent from the source database system 401 to the first storage device 411. However, writing the new record 440ₙ directly on the first storage device 411 without storing it inside the source database system 401 may have the advantage that the target database system 402 may be able to read the new record 440ₙ as soon as possible. The log files 430ᵢ may be stored on the first storage device 411 after and/or during the writing of the log files 430ᵢ. If a size of the actual log file 430ₘ exceeds a given log file size threshold, the further processing unit 450 may lock the actual log file 430ₘ and generate a new actual log file not shown in FIG. 4. If the actual log file 430ₘ is locked, the processor 16 may no longer be able to write one of the further new data change records in the actual log file 430ₘ. Instead, the processor 16 may write one of the further new records in a new actual log file.

In some embodiments, a third operation may comprise archiving a part of the log files 430 being stored on the first storage device 411 on a second memory device 412. In some embodiments, the second memory device 412 may comprise a second access time, the second access time being higher than the first access time, for example about 100 to 200 times higher than the first access time and/or the like. The further processing unit 450 may load the part of the log files 430 from the first storage device 411 and archive it on the second memory device 412. After archiving, the further processing unit 450 may delete the part of the log files 430 on the first storage device 411. As such, space on the first storage device 411 may be created to write the further new records in the actual log file 430ₘ and/or to generate the new actual log file.

In some embodiments, the further processing unit 450 and the first storage device 411 may be considered a data replication engine. In some embodiments, the processor 16 and a replication engine may execute the third operation together.

In some embodiments, the computer system 10 may perform a fourth operation. The fourth operation may comprise performing a first type of data replication (e.g., incremental data replication, etc.). In some embodiments, for example, the processor 216 may execute the fourth operation. The first type of data replication may comprise repeatedly loading one or more of the data change records 440, and replicating a respective data change of a single row of the source table 410 in the target table 420 according to the corresponding individually loaded data change record 440ᵢ.

For example, the first data change record 440₁ shown in FIG. 10, may include a first value of the row number, in this example “2”, and a first value of the column number, in this example “1”, of the source table 410 of a first modified data field being specified by these values and a new value of the first data field, in this example “4812”. The second data change record 440₂ may include a second value of the row number, in this example “1”, and a second value of the column number, in this example “2”, of the source table 410 of a second modified data field being specified by these values and a new value of the second data field, in this example “9001”.

In some embodiments, each record 440ᵢ may include a record number field 441ᵢ containing a record number of the respective record 440, which may indicate a total number of data change records of the source table 410 being written at a respective moment of a generating of the respective record 440ᵢ.

According to the first type of data replication, the target database system 402 may load the first record 440₁ from the first storage device 411 and replicate the data change of the second row of the source table 410 in the target table 420 according to the first record 440₁. Hence, the processor 216 may set the value of the data field of the target table 420 being specified by the row number “2” and column number “1” equal to 4812. Furthermore, according to the first type of data replication, after having performed a replication of data change in the target table 420 according to the first record 440₁, the target database system 402 may load the second record 440₂ from the first storage device 411 and replicate the data change of the first row of the source table 410 in the target table 420 according to the second record 440₂. Hence, the processor 216 may set the value of the data field of the target table 420 being specified by the row number “1” and column number “2” equal to 9001. Thus, the further processing unit 450 may access the first storage device 411 or the second memory device 412 each time one of the first record 440₁ and the second record 440₂ is loaded from the first storage device 411 or the second memory device 412. As such, in this case, for loading the first record 440₁ and the second record 440₂, the first storage device 411 or the second memory device 412 may be accessed twice or the first storage device 411 and the second memory device 412 may each be accessed once.

In some embodiments, the computer system 10 may perform a fifth operation. The fifth operation may comprise performing a second type of data replication (e.g., bulk load data replication, etc.). In some embodiments, for example, the processor 216 may execute the fifth operation. In an example, the second type of data replication may comprise loading all values of the data fields of the source table 410 from the source database system 401 and copying these values in corresponding data fields of the target table 420. Thereby, the processor 216 may load the values of the data fields of the source table 410 in the form of a matrix into the cache memory 232, for example.

In some embodiments, the matrix may represent information for updating several rows of the target table 420 together. The information for updating several rows of the target table 420 may be in the form of the values of the data fields of the source table 410, for example, a partition of values of the data fields (e.g., for a partial bulk load data replication, etc.) or all values of all data fields (e.g., for a full bulk load data replication, etc.) of the source table 410. These data values may be loaded directly from the source database system 401, for example from the storage system 34. The data values of the source table 410 may be loaded together, for example by means of the further processing unit 450, from the source database system 401 to the target database system 402 in the form of the matrix, which may have multiple dimensions. In this case, the data change records 440 may not be used. As an example, the partition of the data values of the source table 410 may depict a certain month if the source table 410 is ordered with respect to dates.

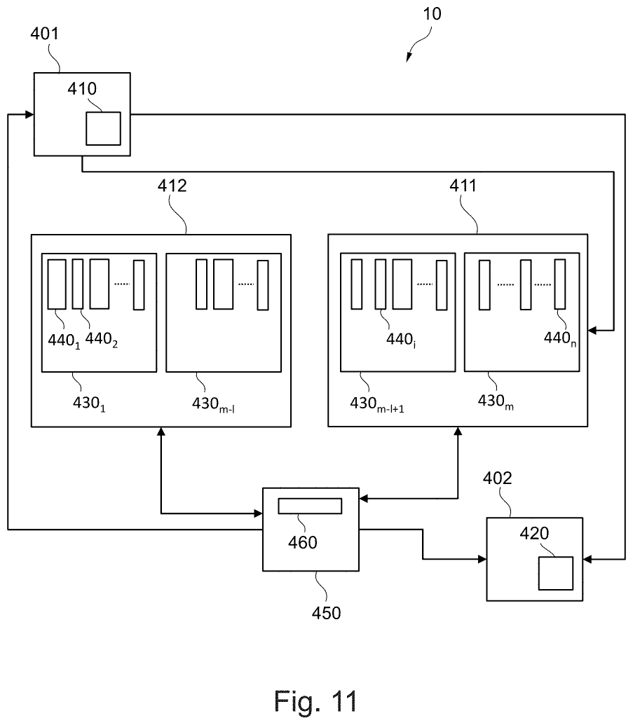

FIG. 11 shows an example where the first record 440₁ and the second record 440₂ are stored on the second memory device 412. A total number of the log files 430 being stored on the first storage device 411 and the second memory device 412 may be equal to m. A number of the log files 430 being stored on the first storage device 411 may be equal to 1.

The m-th log file 430ₘ of the log files 430 may be the youngest log file of the first storage device 411 and the (m−l+1)-th log file 430ₘ₋ₗ₊₁—of the log files 430 may be the oldest log file of the first storage device 411. A number of log files 430 being stored on the second memory device 412 may be equal to m−l. The (m−l)-th log file 430ₘ₋ₗ of the log files 430 may be the youngest log file of the second memory device 412. A first log file 430₁ may be the oldest log file of the second memory device 412. The records of the log files 430 are shown as boxes in FIG. 11.

In some embodiments, a sixth operation may include loading second runtime statistics about processing the data changes of the source table 410 at a second point of time. The loading of the second runtime statistics may comprise loading each value of one or more of the variables 701, 702, 703, 704, 705, 706, 707, and/or 708 from the runtime statistics file 700 at the second point of time. As an example, the processor 16 may generate a second runtime statistics file 452 which may be a copy of the runtime statistics file 700 at the second point of time. The further processing unit 450 may send a second load command to initiate a download of the second runtime statistics file 452 or each value of one or more of the variables 701, 702, 703, 704, 705, 706, 707, and/or 708 from the runtime statistics file 700 from the source database system 401 into the memory 460 of the further processing unit 450.

In some embodiments, a seventh operation may include selection of a type of data replication from the first type of data replication (e.g., incremental data replication, etc.) and the second type of data replication (e.g., bulk load data replication, etc.) based on the first runtime statistics and the second runtime statistics. As an example, in some embodiments, the further processing unit 450 may perform the selection of the type of data replication.

As an example, in some embodiments, the further processing unit 450 may calculate a first difference between the value of the eighth variable 708 of the second runtime statistics file 452 and the value of the eighth variable 708 of the first runtime statistics file 451. The further processing unit 450 may compare the first difference with a second threshold.

If the first difference is less than or equal to the second threshold, the further processing unit 450 may select the first type of data replication, for example. Accordingly, the further processing unit 450 may send a first command to the processor 216 to initialize and/or to resume an execution of the fourth operation, the first type of data replication (e.g., incremental data replication, etc.), on the processor 216, for example.

If the first difference is greater than the second threshold, the further processing unit 450 may select the second type of data replication, for example. Accordingly, the further processing unit 450 may send a second command to the processor 216 to initialize and/or resume an execution of the fifth operation, the second type of data replication (e.g., incremental data replication, etc.) on the processor 216, for example.

As an example, in some embodiments, the further processing unit 450 may track a first number of data changes being replicated in the target table 420 according to the data change records 440 between the first point of time and the second point of time. For example, the processor 216 may comprise a counter, such as counter 217 shown in FIG. 2 for example, for counting the first number of data changes being replicated in the target table 420 between the first point of time and the second point of time. In some embodiments, the processor 216 may send an actual value of the counter 217 to the further processing unit 450 each time the processor 216 updates the counter 217. In some embodiments, the processor 216 may reset the counter 217 at the first point of time. Aa an example, in some embodiments, the further processing unit 450 may initialize a resetting of the counter 217 in response to receiving the first runtime statistics file 451.

In some embodiments, the processing unit may determine a number of pending data changes of the target table 420 based on the first number, the value of the eighth variable 708 of the second runtime statistics file 452 (e.g., the total number of data changes at the first point of time) and the value of the eighth variable 708 of the first runtime statistics file 451, (e.g., the total number of data changes at the second point of time).

In some embodiments, the further processing unit 450 may calculate the number of pending data changes as a difference between the first difference and the first number of data changes being replicated. If the number of pending data changes is calculated in such a manner, the number of pending data changes may be considered as a number of data changes to be replicated to reach a similar state of the computer system 10 at the first point of time. The state of the computer system 10 may involve an amount of free capacity of the first storage device 411. If the free capacity of the first storage device 411 is close to zero, the data replication process may be blocked. If the free capacity of the first storage device 411 reduces from the first point of time to the second point of time, the number of pending data changes may be considered, for example, as a number of data changes to be replicated in order to reach a similar amount of free capacity of the first storage device 411 at the first point of time.

As an example, the further processing unit 450 may select the type of data replication based on the number of the pending data changes of the target table 420.

The number of the pending data changes may be equal to a number of the data changes of the data change records 440, of the log files 430 being stored on the first storage device 411 which are not yet replicated in the target table 420, for example, at the second point of time. According to this example, the first storage device 411 may be empty at the first point of time. The number of the pending data changes may be determined by counting the records stored on the first memory device 411 starting from the oldest data change record of the oldest log file 430ₘ₋ₗ₊₁ of the first storage device 411 counting onwards to the youngest data change record of the youngest log file 430ₘ of the first storage device 411. However, in doing so all the data change records of the first storage device 411 may have to be read.

In some embodiments, the further processing unit 450 may compare the number of the pending data changes with a first threshold.

If the number of the pending data changes is less than or equal to the first threshold, the further processing unit 450 may select the first type of data replication. Accordingly, the further processing unit 450 may send the first command to the processor 216 to initialize or to resume an execution of the fourth operation, that is the first type of data replication (e.g., incremental data replication, etc.), on the processor 216.

If the number of the pending data changes is greater than the first threshold, the further processing unit 450 may select the second type of data replication. Accordingly, the further processing unit 450 may send the second command to the processor 216 to initialize or resume an execution of the fifth operation, that is the second type of data replication (e.g., bulk load data replication, etc.), on the processor 216.

In some embodiments, the further processing unit 450 may determine the first threshold such that a length of a first period of time for performing the number of the pending data changes of the target table 420 according to the first type of data replication is approximately equal to a length of a second period of time for copying all data values of the source table 410 to the target table 420, for example, by performing the first type of data replication. Furthermore, the further processing unit 450 may determine the first threshold based on the first access time of the first storage device 411 and/or an access time of the target database system 401. The access time of the target database system 401 may include a period of time required to perform a single write operation on the target table 420.

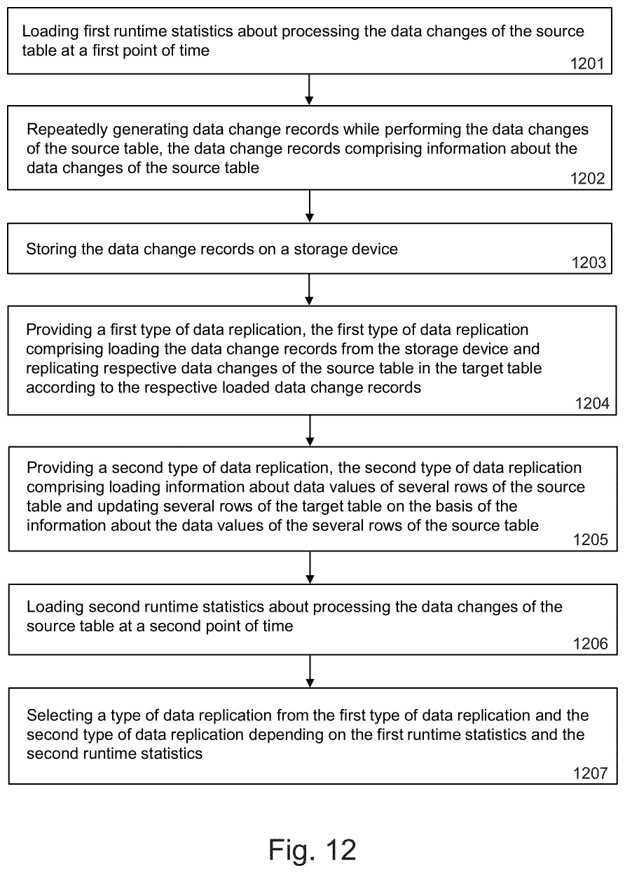

FIG. 12 shows a flowchart of a computer implemented method for replicating data changes of the source table 410 of a source database system 401 in the target table 420.

In operation 1201, the first runtime statistics about processing the data changes of the source table 410 may be loaded at the first point of time. For example, the further processing unit 450 may load the first runtime statistics file 451 from the source database system 401 into the memory 460.

In operation 1202, the data change records 440 may be generated repeatedly while performing the data changes of the source table 410, for example, by writing information about processing the data changes into the log files 430.

In operation 1203, the data change records 440 may be stored on a storage device, for example, on the first storage device 411.

In operation 1204, the first type of data replication may be provided. The first type of data replication may comprise loading the data change records 440 from the first storage device 411 and replicating respective data changes of the source table 410 in the target table 420 according to the respective loaded data change records 440.

In operation 1205, the second type of data replication may be provided. The second type of data replication may comprise loading information about data values of several rows of the source table 410 and updating several rows of the target table 420 based on the information about the data values of the several rows of the source table 410.

In operation 1206, the second runtime statistics about processing the data changes of the source table may be loaded at the second point of time. For example, the further processing unit 450 may load the second runtime statistics file 452 from the source database system 401 into the memory 460.

In operation 1207, a type of data replication from the first type of data replication and the second type of data replication may be selected based on the first runtime statistics and the second runtime statistics. The selecting of the type of data replication may involve the above-mentioned variants, such as including a calculation of the number of the pending data changes, for example.

The computer system 10 may be a standalone computer with no network connectivity that may receive data to be processed through a local interface. Such operation may, however, likewise be performed using a computer system that is connected to a network such as a communications network and/or a computing network.

FIG. 3 shows an exemplary computing environment where a computer system such as computer system 10 is connected, e.g., using the network adapter 20, to a network 200. Without limitation, the network 200 may be a communications network such as the internet, a local-area network (LAN), a wireless network such as a mobile communications network, and the like. The network 200 may comprise a computing network such as a cloud-computing network. The computer system 10 may receive data to be processed from the network 200 and/or may provide a computing result to another computing device connected to the computer system 10 via the network 200.

The computer system 10 may perform operations described herein, such as the first, second, third, fourth, fifth, sixth, and seventh operation, for example, entirely or in part, in response to a request received via the network 200. In particular, the computer system 10 may perform such operations in a distributed computation together with one or more further computer systems that may be connected to the computer system 10 via the network 200. For that purpose, the computing system 10 and/or any further involved computer systems may access further computing resources, such as a dedicated and/or shared memory, using the network 200.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer implemented method comprising:
loading first runtime statistics about processing data changes of a source table at a first point of time;
repeatedly generating data change records while performing the data changes of the source table, the data change records comprising information about the data changes of the source table;
storing the data change records on a storage device;
loading second runtime statistics about processing the data changes of the source table at a second point of time; and
selecting a type of data replication from a first type of data replication and a second type of data replication based on the first runtime statistics and the second runtime statistics;
wherein the first type of data replication includes loading the data change records from the storage device and replicating respective data changes of the source table in a target table according to respective loaded data change records; and
wherein the second type of data replication includes loading information about data values of several rows of the source table and updating several rows of the target table based on the information about the data values of the several rows of the source table.

2. The computer implemented method of claim 1, wherein the loading of the information about the data values of several rows of the source table comprises loading all data values of the source table from a source database system.

3. The computer implemented method of claim 1, wherein the loading of the first runtime statistics comprises a loading of information about a first total number of data changes of the source table at the first point of time; and the loading of the second runtime statistics comprising a loading of information about a second total number of the data changes of the source table at the second point of time;
wherein the method further comprises selecting the type of data replication based on the information about the first total number of the data changes and the information about the second total number of the data changes.

4. The computer implemented method of claim 3, the method further comprising:
replicating a first number of the data changes of the source table in the target table according to the data change records on the storage device and according to the first type of data replication between the first point of time and the second point of time;
determining a number of pending data changes of the target table based on the first number, the first total number of data changes, and the second total number of data changes; and
selecting the type of data replication from the first type of data replication and the second type of data replication based on the number of the pending data changes of the target table.

5. The computer implemented method of claim 4, wherein the second type of data replication is selected and the loading of the information about the data values of the several rows of the source table comprises loading all data values of the source table, and wherein the method further comprises:
resetting a counter for counting a first number of data changes;
loading of the information about the first total number of the data changes of the source table at the first point of time, with the first total number being an updated first total number and with the first point of time being an updated first point of time;
repeatedly generating of the data change records while performing the data changes of the source table, with the data change records being updated data change records;
storing of the data change records on the storage device;
replicating of the first number of the data changes of the source table in the target table according to the data change records on the storage device and according to the first type of data replication between the first point of time and the second point of time, the first number of the data changes being an updated first number of the data changes, the data change records on the storage device being updated data change records on the storage device, the second point of time being an updated second point of time;
loading of the information about the second total number of the data changes of the source table at the second point of time, with the second total number being an updated second total number;
determining of the number of the pending data changes of the target table based on the first number of the data changes, the first total number of the data changes and the second total number of the data changes, the number of the pending data changed being an updated number of the pending data changes; and
selecting of the type of data replication from the first type of data replication and the second type of data replication depending on the number of the pending data changes of the target table.

6. The computer implemented method of claim 4, wherein the first type of data replication is selected, and wherein the method further comprises:
resetting a counter for counting the first number of data changes;
replacing the information about the first total number of the data changes with the information about the second total number of the data changes;
repeatedly generating of the data change records while performing the data changes of the source table, with the data change records being updated data change records;
storing of the data change records on the storage device;
replicating of the first number of the data changes of the source table in the target table according to the data change records on the storage device and according to the first type of data replication between the first point of time and the second point of time, the first number of the data changes being an updated first number of the data changes, the data change records on the storage device being updated data change records on the storage device, the second point of time being an updated second point of time;
loading of the information about the second total number of the data changes of the source table at the second point of time, with the second total number being an updated second total number;
determining of the number of the pending data changes of the target table based on the first number of the data changes, the first total number of the data changes and the second total number of the data changes, the number of the pending data changed being an updated number of the pending data changes; and
selecting of the type of data replication from the first type of data replication and the second type of data replication depending on the number of the pending data changes of the target table.

7. The computer implemented method of claim 4, the method further comprising selecting the second type of data replication if the number of the pending data changes of the target table is greater than a first threshold.

8. The computer implemented method of claim 7, the method further comprising determining the first threshold such that a length of a first period of time for performing the number of the pending data changes of the target table according to the first type of data replication is approximately equal to a length of a second period of time for copying all data values of the source table to the target table.

9. The computer implemented method of claim 8, the method further comprising determining the first threshold based an access time of the storage device.

10. The computer implemented method of claim 8, the method further comprising determining the first threshold based an access time of a target database system, the target table being stored on the target database system.

11. The computer implemented method of claim 3, the method further comprising selecting the type of data replication from the first type of data replication and the second type of data replication based on a difference between the second total number and the first total number.

12. The computer implemented method of claim 3, the method further comprising selecting the type of data replication from the first type of data replication and the second type of data replication based on a difference between the second total number and the first total number and a number of pending queries on a source database system.

13. The computer implemented method of claim 3, the method further comprising selecting the type of data replication from the first type of data replication and the second type of data replication based on a rate of data changes per time of the source table, the rate of data changes per time being dependent on a difference between the first total number and the second total number and a length of a time interval between the first point of time and the second point of time.

14. The computer implemented method of claim 1, wherein the loading of the information about the data values of several rows of the source table comprises loading the data values of several rows of the source table from the source database system, the several rows being a subset of all rows of the source table.

15. A computer program product comprising one or more computer-readable storage media, and program instructions collectively stored on the one or more computer-readable storage media, the program instructions executable by one or more processors to perform a method comprising:
loading first runtime statistics about processing data changes of a source table at a first point of time;
repeatedly generating data change records while performing the data changes of the source table, the data change records comprising information about the data changes of the source table;
storing the data change records on a storage device;
loading second runtime statistics about processing the data changes of the source table at a second point of time; and
selecting a type of data replication from a first type of data replication and a second type of data replication based on the first runtime statistics and the second runtime statistics;
wherein the first type of data replication includes loading the data change records from the storage device and replicating respective data changes of the source table in a target table according to respective loaded data change records; and
wherein the second type of data replication includes loading information about data values of several rows of the source table and updating several rows of the target table based on the information about the data values of the several rows of the source table.

16. The computer program product of claim 15, wherein the loading of the first runtime statistics comprises a loading of information about a first total number of data changes of the source table at the first point of time, wherein the loading of the second runtime statistics comprising a loading of information about a second total number of data changes of the source table at the second point of time;
wherein the method further comprises selecting the type of data replication based on the information about the first total number of the data changes and the information about the second total number of the data changes.

17. The computer program product of claim 16, the method further comprising:
replicating a first number of the data changes of the source table in the target table according to the data change records on the storage device and according to the first type of data replication between the first point of time and the second point of time;
determining a number of pending data changes of the target table based on the first number, the first total number of data changes, and the second total number of data changes; and
selecting the type of data replication from the first type of data replication and the second type of data replication based on the number of the pending data changes of the target table.

18. A computer system comprising:
a processor set; and
a computer readable storage medium;
wherein:
the processor set is structured, located, connected, and programmed to run program instructions stored on the computer readable storage medium; and
the stored program instructions include:
program instructions programmed to load first runtime statistics about processing data changes of a source table at a first point of time;
program instructions programmed to repeatedly generate data change records while performing the data changes of the source table, the data change records comprising information about the data changes of the source table;
program instructions programmed to store the data change records on a storage device;
program instructions programmed to load second runtime statistics about processing the data changes of the source table at a second point of time; and
program instructions programmed to select a type of data replication from a first type of data replication and a second type of data replication based on the first runtime statistics and the second runtime statistics;
wherein the first type of data replication includes loading the data change records from the storage device and replicating respective data changes of the source table in a target table according to respective loaded data change records; and
wherein the second type of data replication includes loading information about data values of several rows of the source table and updating several rows of the target table based on the information about the data values of the several rows of the source table.

19. The computer system of claim 18, wherein the loading of the first runtime statistics comprises a loading of information about a first total number of data changes of the source table at the first point of time, wherein the loading of the second runtime statistics comprises a loading of information about a second total number of data changes of the source table at the second point of time;
wherein the stored program instructions further include program instructions programmed to select the type of data replication based on the information about the first total number of data changes and the information about the second total number of data changes.

20. The computer system of claim 19, wherein the stored program instructions further include:
program instructions programmed to replicate a first number of data changes of the source table in the target table according to the data change records on the storage device and according to the first type of data replication between the first point of time and the second point of time;
program instructions programmed to determine a number of pending data changes of the target table based on the first number, the first total number of data changes, and the second total number of data changes; and
program instructions programmed to select the type of data replication from the first type of data replication and the second type of data replication based on the number of pending data changes of the target table.
